(19) United States
(12) Patent Application Publication
(10) Pub. No.: US 2008/0134831 A1
(43) Pub. Date: Jun. 12, 2008

(54) Swing lever structure for use in jacks

(75) Inventor: Larry Lee, Taichung (TW)

Correspondence Address: Larry Lee, P.O. Box 44-2049, Taipei, 10668, omitted

(73) Assignee: Tien-I Industrial Co., Ltd

(21) Appl. No.: 11/987,589

(22) Filed: Dec. 3, 2007

(30) Foreign Application Priority Data
Dec. 12, 2006 (TW) 095221862

(51) Int. Cl. G05G 1/04

(52) U.S. Cl. 74/522.5

(57) ABSTRACT

A swing lever structure for use in jacks comprises a swing lever including a coupling mechanism extendedly provided on one end thereof and having a stop plane formed on at lease one side thereof, and including a driving stem having a connecting end formed on one end thereof for pivotally connecting with the coupling mechanism of the swing lever, thus enabling a jointed rotation, the connecting end further including a stopping surface affixed on at least one side thereof relative to the stop plane of the swing lever, thereby the swing lever and the driving stem may be relatively rotated to form a preferred included angle therebetween so as to facilitate the operation of a jack in a narrow place.

### BACKGROUND OF THE INVENTION

(1) Field of the Invention

The present invention relates to a jack, and more particularly to a swing lever structure for use in jacks that may facilitate the operation of a jack in a narrow place.

(2) Description of the Prior Arts

While car is broken on the road, such as having a punctured or flat tire, the driver has to takes out of a spare tire from the trunk, and then to change tire by means of a jack. However, if a prior art jack as shown in FIG. 1 is operated in a limited narrow place, bring out an inconvenient operation.

The present invention has arisen to mitigate and/or obviate the afore-described disadvantages.

### SUMMARY OF THE INVENTION

The primary object of the present invention is to provide a swing lever structure for use in jacks that may facilitate the operation of a jack in a narrow place.

In accordance with one aspect of the present invention, there is provided a swing lever structure for use in jacks comprising a swing lever and a driving stem axially connected together for urging the vertical movement of a jack.

The swing lever is constructed in the shape of an elongated shaft, on one end of which is extendedly provided with a coupling mechanism including a recess arranged at one side thereof. The recess includes two stop planes formed at two inner sides thereof respectively, and each having an axial hole disposed at a proper position thereof, the swing lever further includes an elongated slot extendedly mounted at one side thereof and having a positioning device attached at a predetermined position of the inner side thereof, wherein the positioning device is shaped in the form of an annular projection, hence as the driving stem rotates into the elongated slot, it may be further retained therein.

The driving stem is constructed in the form of an elongated hook, and includes a connecting end formed on one end thereof and a hook-shaped driving end arranged on another end thereof for fitting at a retaining end of an elongated screw, therefore a vertical movement of the jack may be obtained. The driving stem further includes two stopping surfaces affixed on two sides of the connecting end individually and having a bore passing therethrough for corresponding to the axial holes of the swing lever. By using a bolt element, the swing lever and the driving stem are in turn axially assembled together and then securely screwed by way of a nut, thereby the connecting end allows to pivotally connect with the coupling mechanism of the swing lever for a jointed rotation. For example, as the swing lever and the driving stem relatively rotate to form an included angle therebetween, such as 90 degree, the stop planes of the swing lever relatively force the stopping surfaces of the driving stem to rotate, thus actuating the movement of the elongated screw of the jack.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is a perspective diagram illustrating the assembly of a prior art jack provided with a swing lever;

FIG. 2 is a perspective diagram illustrating the assembly of a jack provided with a swing lever according to the present invention;

FIG. 3 is a perspective diagram illustrating the exploded components of a swing lever structure for use in jacks according to the present invention;

FIG. 4 is a perspective diagram illustrating the operation of the swing lever structure for use in jacks according to the present invention;

FIG. 5 is a perspective diagram illustrating the storage status of the swing lever structure for use in jacks according to the present invention.

### DETAILED DESCRIPTION OF THE PREFERRED EMBODIMENTS

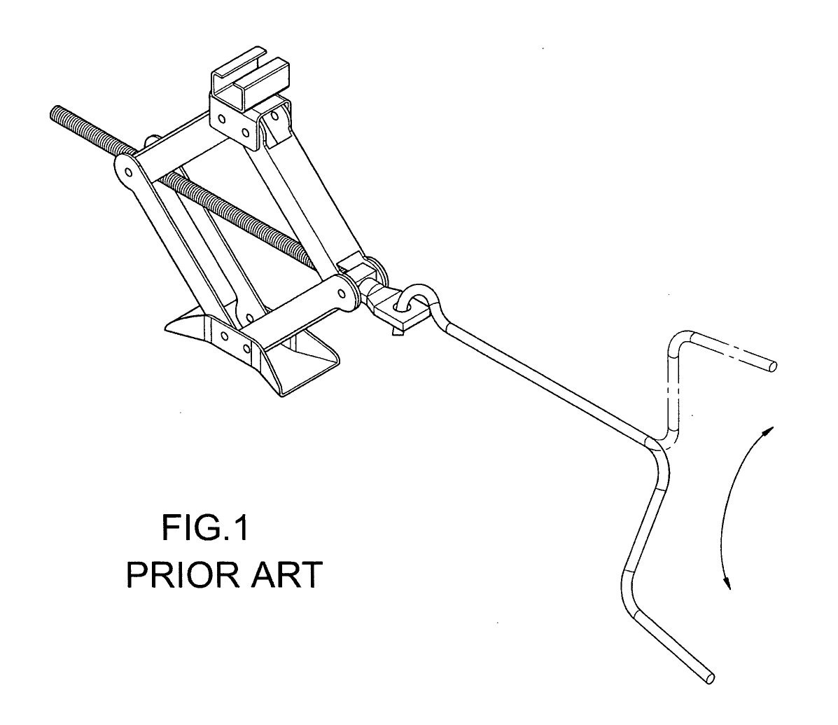

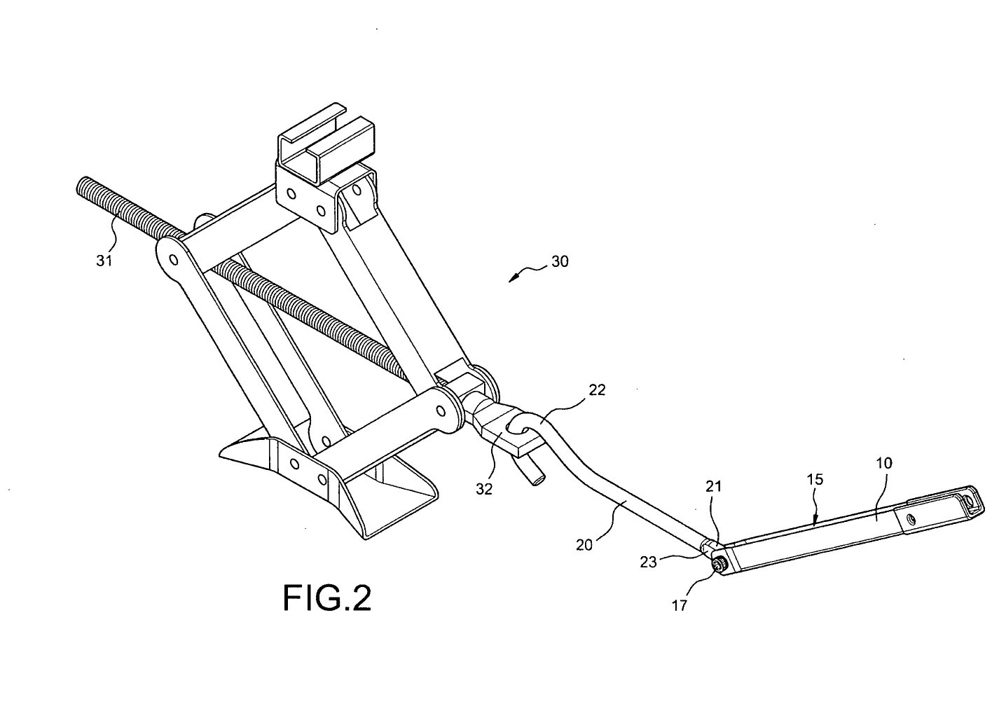

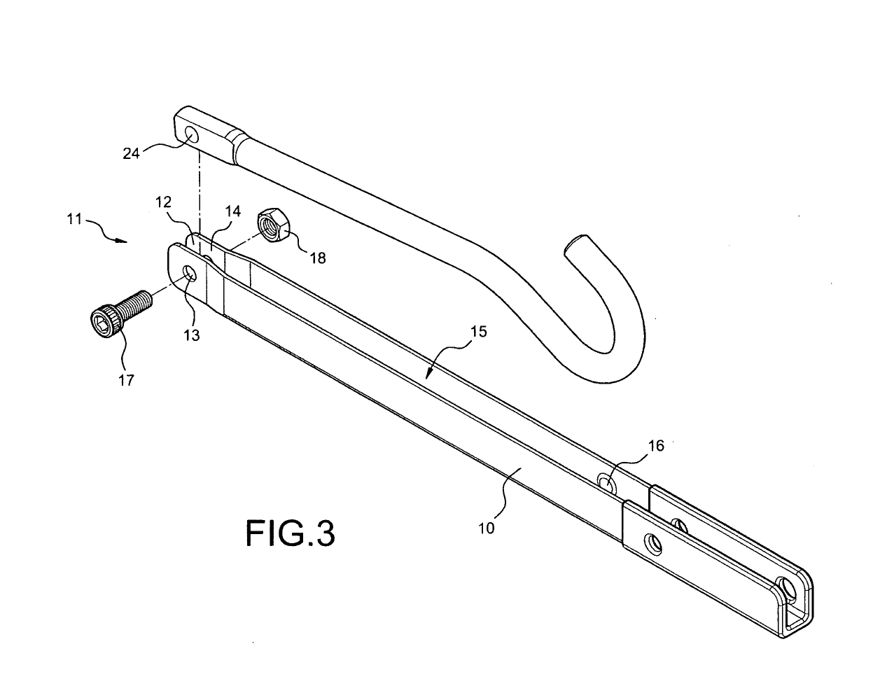

Referring to FIGS. 1-4, a swing lever structure for use in jacks in accordance with the present invention comprises a swing lever 10 and a driving stem 20 axially connected together for urging the vertical movement of a jack 30.

The swing lever 10 is constructed in the shape of an elongated shaft, on one end of which is extendedly provided with a coupling mechanism 11 including a recess 12 arranged at one side thereof. The recess 12 includes two stop planes 14 formed at two inner sides thereof respectively, and each having an axial hole 13 disposed at a proper position thereof, the swing lever 10 further includes an elongated slot 15 extendedly mounted at one side thereof and having a positioning device 16 attached at a predetermined position of the inner side thereof, wherein the positioning device 16 is shaped in the form of an annular projection, hence as the driving stem 20 rotates into the elongated slot 15, it may be further retained therein.

The driving stem 20 is constructed in the form of an elongated hook, and includes a connecting end 21 formed on one end thereof and a hook-shaped driving end 22 arranged on another end thereof for fitting at a retaining end 32 of an elongated screw 31, thus a vertical movement of the jack 30 may be obtained. The driving stem 20 further includes two stopping surfaces 23 affixed on two sides of the connecting end 21 individually and having a bore 24 passing therethrough for corresponding to the axial holes 13 of the swing lever 10. By using a bolt element 17, the swing lever 10 and the driving stem 20 are in turn axially assembled together and then securely screwed by way of a nut 18, thereby the connecting end 21 allows to pivotally connect with the coupling mechanism 11 of the swing lever 10 for a jointed rotation. For example, as the swing lever 10 and the driving stem 20 relatively rotate to form an included angle therebetween, such as 90 degree, the stop planes 14 of the swing lever 10 relatively force the stopping surfaces 23 of the driving stem 20 to rotate, thus actuating the movement of the elongated screw 31 of the jack 30.

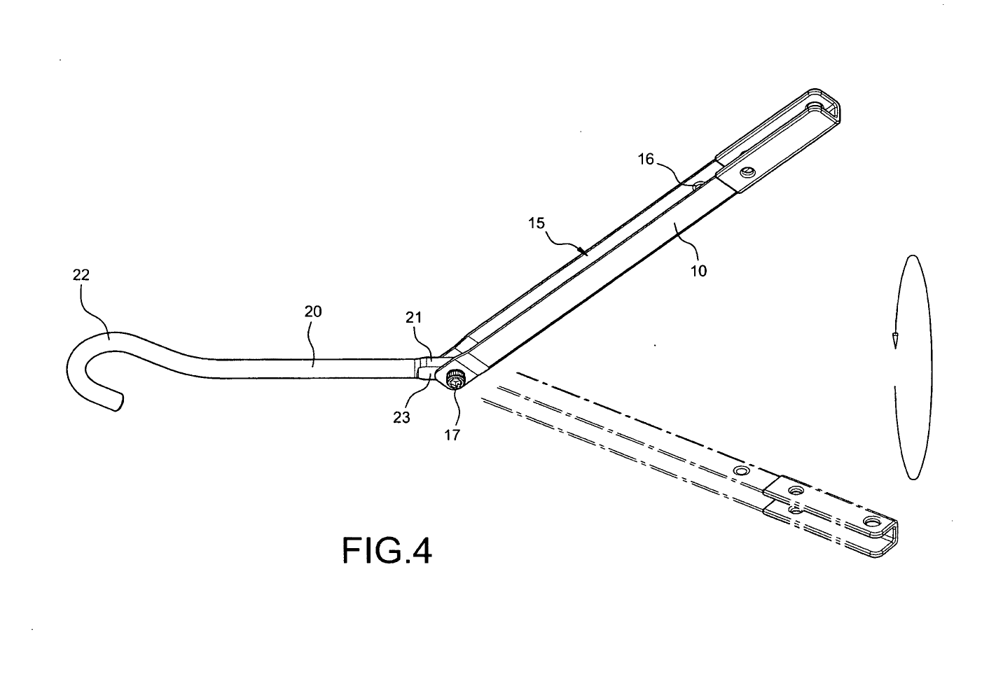

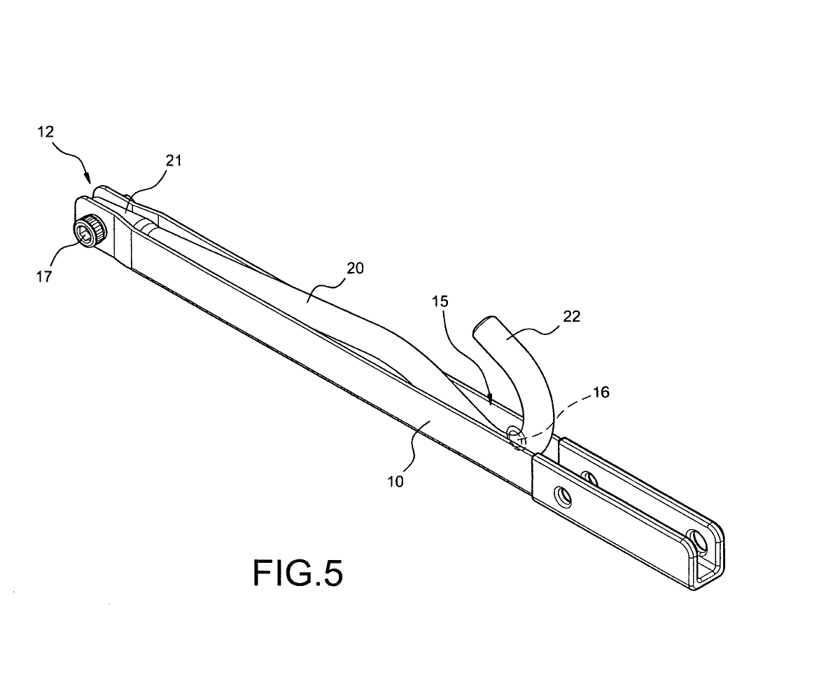

In operation, the swing lever 10 is rotated to drive the driving stem 20 for causing the vertical movement of the jack 30, because the driving end 22 of the driving stem 20 fits at the retaining end 32 of the elongated screw 31 of the jack 30, the swing lever 10 and the driving stem 20 are relatively rotated to form an included angle therebetween, e.g. 90 degree, and then the driving stem 20 may be used as an axial center for rotating the swing lever 10. By means of the stop planes 14 of the swing lever 10, the stopping surfaces 23 of the driving stem 20 are relatively driven to actuate the elongated screw 31 for urging the vertical movement of the jack 30. Thereafter, while the rotation of the swing lever 10 is confined by an obstacle, by virtue of the coupling mechanism 11, the swing lever 10 relatively rotates toward another side of the driving stem 20 for the further operation as illustrated in FIG. 4. On the other hand, while in the storing operation, the driving stem 20 is rotatably stored in the elongated slot 15 of the swing lever 10, and then the driving stem 20 is retained by the positioning device 16 of the swing lever 10 as shown in FIG. 5, such that the swing lever 10 and the driving stem 20 permit to relatively rotate to form a preferred included angle therebetween, facilitating the operating of the jack 30 in a limited operating place.

It can be clearly seen from the preceding accounts on the features of the present invention that the swing lever structure for use in jacks of the present invention has the following advantage:

While the rotation of the swing lever 10 is confined in a narrow place, the swing lever 10 and the driving stem 20 may be relatively rotated to form a preferred included angle therebetween, thereby facilitating the operation of the jack 30.

The invention is not limited to the above embodiment but various modifications thereof may be made. It will be understood by those skilled in the art that various changes in form and detail may made without departing from the scope and spirit of the present invention.

What is claimed is:

1. A swing lever structure for use in jacks comprising:
a swing lever including a coupling mechanism extendedly provided on one end thereof and having a stop plane formed on at lease one side thereof;
a driving stem including a connecting end formed on one end thereof for pivotally connecting with said coupling mechanism of said swing lever, thus enabling a jointed rotation, said connecting end further including a stopping surface affixed on at least one side thereof relative to said stop plane of said swing lever;
thereby said swing lever and said driving stem may be relatively rotated to form a preferred included angle therebetween so as to facilitate the operation of a jack in a narrow place.

2. The swing lever structure for use in jacks as claimed in claim 1, wherein said coupling mechanism further includes a recess arranged therein and having an axial hole passing through the side walls thereof, said connecting end of said driving stem may be correspondingly mounted at said recess, and a bore of said driving stem aligns with said axial hole of said swing lever, by using a bolt element, said swing lever and said driving stem are in turn axially assembled together and then securely screwed by way of a nut, thereby said connecting end allows to pivotally connect with said coupling mechanism of said swing lever for a jointed rotation.

3. The swing lever structure for use in jacks as claimed in claim 1, wherein said swing lever further includes an elongated slot extendedly mounted at one side thereof and having a positioning device attached at a predetermined position of the inner side thereof, said positioning device is shaped in the form of an annular projection, hence as said driving stem rotates into said elongated slot, it may be further retained firmly.
